(19) United States
(12) Patent Application Publication
(10) Pub. No.: US 2017/0032370 A1
(43) Pub. Date: Feb. 2, 2017

(54) ELECTRONIC PAYMENT TRANSACTIONS USING MACHINE READABLE CODE WITHOUT REQUIRING ONLINE CONNECTION

(71) Applicant: MasterCard International Incorporated, Purchase, NY (US)

(72) Inventors: Gabriel Beltramino, New York, NY (US); Axel Cateland, Scarsdale, NY (US); Maurice David Liscia, Long Island City, NY (US)

(21) Appl. No.: 14/810,077

(22) Filed: Jul. 27, 2015

(51) Int. Cl. G06Q 20/40; G06Q 20/36; G06Q 20/38

(52) U.S. Cl. CPC G06Q 20/405; G06Q 20/3829; G06Q 20/4012; G06Q 20/36

(57) ABSTRACT

Processes and systems for facilitating purchase transactions with a mobile device. In an embodiment, a mobile device processor receives an indication to conduct a purchase transaction, initializes a secure mobile wallet application and receives a selection of a payment account. The mobile device processor then retrieves a pre-loaded wallet single use key (W_SUK) from a secure storage component, derives a wallet session key (W_SK) utilizing the W_SUK, encrypts transaction data using the W_SK, generates a machine readable code utilizing the encrypted transaction data, and displays the machine readable code on a display screen for reading by a merchant scanner to continue the processing of the purchase transaction.

### FIELD OF THE DISCLOSURE

Embodiments described herein generally relate to methods and systems for facilitating transactions using a mobile device without requiring the mobile device to be connected online. In some embodiments, a secure wallet application stored on a consumer's mobile device operates to pre-load one or more single use keys and transaction identifiers, which are subsequently utilized when the mobile device is offline to generate machine readable codes for conducting secure transactions with merchants.

### BACKGROUND

Mobile wallet payment transaction systems are known, wherein mobile electronic devices such as mobile handsets, cell phones, smartphones, personal digital assistants (PDAs), personal music players, laptops, handheld computing devices, tablet computers and the like, are provisioned with a mobile wallet application for processing and management of secure payment transactions with a payment service provider. In order to request, authorize, verify, process and confirm a payment transaction using machine readable code, the mobile wallet application typically requires the consumer's mobile electronic device to be “on-line” or connected via another type of data network, such as a cellular network, wireless or Wi-Fi data network. Typically, when the consumer's mobile electronic device goes “off-line” and/or disconnects from the data network, then the payment capability of the mobile wallet application on that mobile device is disabled. Thus, in order to conduct a payment transaction using machine readable code in a merchant's retail store location, a secure and reliable network connection must be provided, which can present a challenge for both the merchant and consumers.

In order to encourage mobile wallet purchase transactions, a merchant must typically provide a reliable and/or strong internet connection in each of that merchant's retail store locations, either by providing open (unsecure) Wi-Fi hotspots (which may raise security concerns) or by making sure that each store location does not detrimentally affect the data network coverage (such as cellular coverage) of consumer mobile devices in any way (for example, a retail store cannot be located within a building having poor or nonexistent cellular signals, or in any location that has poor internet coverage). In addition, a consumer must ensure that his or her mobile device can connect to the internet and/or other data network within the store location and stay connected throughout the processing of a purchase transaction. Moreover, when a consumer travels internationally, he or she may incur additional cellular connection roaming charges when utilizing the mobile wallet application at the time of purchase in a foreign retail store.

What is desired is a secure and seamless mobile device payment transaction method and/or system that facilitates purchase transactions using machine readable code without requiring the consumer's mobile device to be “online” or otherwise connected to a data network.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate exemplary embodiments and which are not necessarily drawn to scale, wherein:

FIG. 1 is a block diagram showing a portion of a payment system for implementing offline mobile device purchase transactions in accordance with embodiments of the disclosure;

FIG. 2 is a block diagram of a payment system to illustrate details of a payment transaction in accordance with embodiments of the disclosure;

FIG. 3 is a block diagram of a secure storage component of a consumer mobile device to illustrate software aspects according to embodiments of the disclosure;

FIG. 4A is a flowchart of a secure mobile wallet application pre-loading process in accordance with aspects of the disclosure;

FIG. 4B is a flowchart illustrating another embodiment of a secure mobile wallet application pre-loading process in accordance with novel aspects described herein; and

FIG. 5 is a flowchart of a secure purchase transaction performed by a mobile device which is offline in accordance with aspects described herein.

### DETAILED DESCRIPTION

Reference will now be made in detail to various novel embodiments, examples of which are illustrated in the accompanying drawings. It should be understood that the drawings and descriptions thereof are not intended to limit the disclosure herein to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

In general, and for the purpose of introducing concepts of novel embodiments described herein, described are processes and systems for facilitating purchase transactions with a mobile device which is offline in-store at a merchant location. In particular, a consumer uses his or her mobile device and a mobile wallet to make in-store purchases when the mobile device is offline in accordance with processes and systems described herein. In some embodiments, a consumer downloads and/or installs a secure mobile wallet application onto his or her mobile device. The secure mobile wallet application is operable to pre-load one or more single use keys and associated transaction identifiers when the consumer's mobile device is connected to a network, such as the internet or a cellular network. In particular, when the consumer's mobile device is online, the secure mobile wallet application transmits a request for wallet single use keys and transaction keys to a Wallet Server computer, which request includes a Wallet identifier. The Wallet Server computer receives the request and generates wallet transaction single use keys and transaction identifiers and transmits them back to the consumer's mobile device where they are stored in a secure storage component. Thereafter, when the consumer wishes to make an in-store purchase with his or her mobile device, and there is no connectivity in the merchant's store, then the secure mobile wallet application retrieves a single use key from a secure storage component on the mobile device and derives a session key based on the single use key and a Mobile personal identification number (Mobile PIN). The secure mobile wallet application then functions to encrypt the transaction data using the wallet session key, wherein the transaction data includes data such as the transaction identifier, the wallet identifier, a card identifier and a timestamp. The secure mobile wallet application next causes a machine readable code to be generated for the purchase transaction, which is displayed on a display screen of the consumer's mobile device. A code reader associated with the merchant's point of sale (POS) terminal reads the machine readable code, and then the POS terminal transmits the QR code to a merchant server computer (of the merchant's system) for further processing. Such processing includes communicating with a wallet server to determine whether or not the single use key and transaction identifier of the QR code matches a stored single use key and transaction identifier. If so, then further payment transaction processing occurs, which involves transmitting a purchase authorization request to a payment network and an appropriate issuer financial institution (FI). If all is in order, then the issuer FI authorizes the purchase transaction and the merchant's POS terminal eventually receives a purchase transaction authorization indication. The purchase transaction authorization is typically displayed at the POS terminal to notify the merchant and the consumer of payment, and so that the merchant will allow the consumer to leave the merchant's store with the merchandise. Thus, novel aspects disclosed herein advantageously permit a consumer to conduct a purchase transaction in a merchant retail store location whether wireless connectivity is available or is unavailable in that store location.

A number of terms will be used herein. The use of such terms are not intended to be limiting, but rather are used for convenience and ease of exposition. For example, as used herein, the term “cardholder” may be used interchangeably with the term “consumer” and are used herein to refer to a consumer, person, individual, business or other entity that owns (or is authorized to use) a financial account such as a payment card account (such as a credit card account). In addition, the term “payment card account” may include a credit card account, a debit card account, and/or a deposit account or other type of financial account that an account holder may access. The term “payment card account number” includes a number, or some other indicator, that identifies a payment card system account or a number carried by a payment card, and/or a number, or some other indicator, that is used to route a transaction in a payment system that handles debit card and/or credit card transactions and the like. Moreover, as used herein the terms “payment card system” and/or “payment network” and/or “payment card network” refer to a system and/or network for processing and/or handling purchase transactions and related transactions, which may be operated by a payment card system operator, or other networks that process payment transactions on behalf of a number of merchants, issuers and payment account holders (such as credit card and/or debit card account cardholders). An example of a suitable payment system is the well-known Banknet™ system operated by MasterCard International Incorporated, the assignee hereof. In addition, the terms “payment card network data” or “payment card transaction data” or “network transaction data” or “payment account transaction data” refer to transaction data associated with purchase transactions and/or payment transactions that have been processed over a payment network. For example, network transaction data may include a number of data records associated with individual payment transactions (or purchase transactions) of consumers that have been processed over a payment card network. In some embodiments, network transaction data may include information that identifies a payment device and/or payment account, transaction date and time, transaction amount, information identifying a merchant and/or a merchant category, and/or additional transaction details.

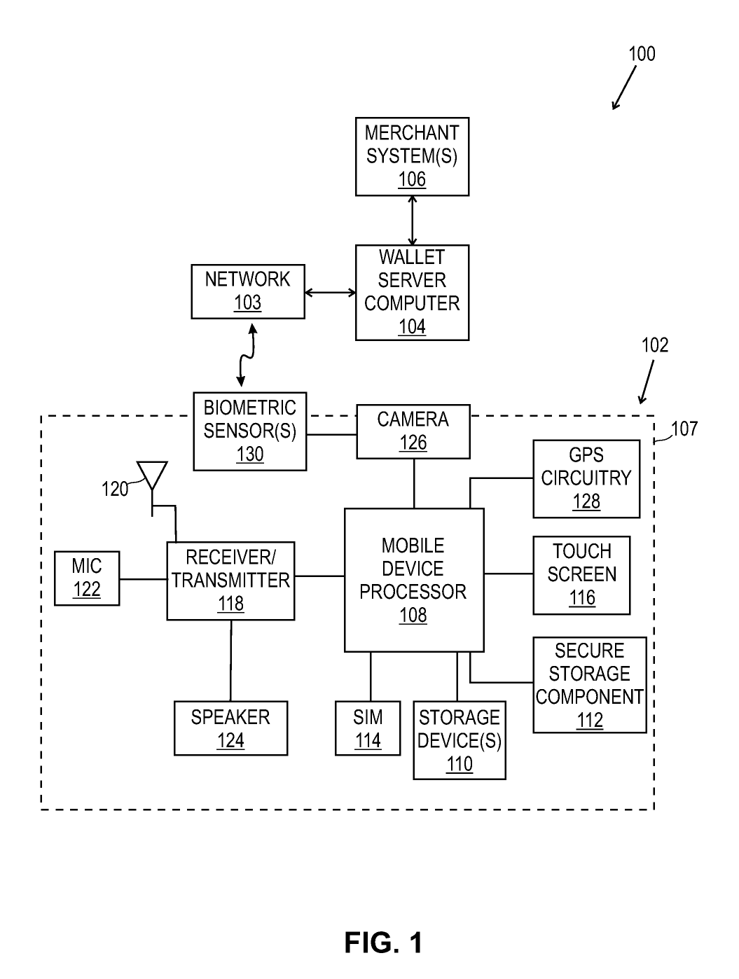

FIG. 1 is a block diagram 100 showing a portion of a payment system for implementing offline mobile device purchase transactions in accordance with embodiments described herein. In particular, a consumer (not shown) has a mobile device 102 operable, via a network 103, to communicate with a wallet server computer 104. The network 103 may be, for example, a public network, such as the internet, or may be a proprietary network, or may be a wireless network operated by a mobile network operator (MNO). The wallet server computer 104 is also configured for communicating with one or more merchant systems 106. The mobile device 102 may be a mobile telephone such as iPhone™ or an Android™ smartphone, or may be a tablet computer, such as an iPad™, a laptop computer, a digital music player, a personal digital assistant (PDA) and/or the like, which has wireless communications capability (for example, components for connecting to a cellular network, and/or to the internet and/or to a proprietary network). For illustrative purposes, the example mobile device 102 shown in FIG. 1 is a mobile telephone, but it may be any type of mobile device capable of utilizing a payment application to carry out payment transactions in a payment card system in accordance with embodiments described herein. It should be understood that, in some implementations, the novel functionality described herein may result at least partially from software and/or firmware that improves and/or transforms one or more components, such as one or more controllers and/or control circuits and/or mobile device processors of a mobile device such as the mobile telephone 102.

The example mobile telephone 102 of FIG. 1 may include a conventional housing (indicated by dashed line 107) that contains and/or supports the other components of the mobile telephone 102. In the illustrated embodiment, the mobile telephone 102 includes a mobile device processor 108 for controlling over-all operation, which may be suitably programmed to allow the mobile telephone 102 to engage in data communications and/or text messaging with other wireless devices and/or electronic devices. The mobile device processor 108 may also be configured to allow for interaction over the internet with web pages accessed via browser software (not separately shown). Other components of the mobile telephone 102 which are in communication with and/or are controlled by the control circuitry or mobile device processor 108 include one or more storage devices 110 (for example, non-transitory program memory devices and/or working memory, and the like), a secure storage component 112, a subscriber identification module (SIM) card 114, and a touch screen display 116 for displaying information and for receiving user or consumer input. In some implementations, the secure storage component 112 is utilized to store mobile wallet data of a consumer and/or other types of consumer data, as well as for storing a secure mobile wallet application and/or other mobile device applications. For example, the secure storage component 112 may store mobile wallet data or information associated with a consumer which identifies one or more payment card accounts, biometric data of the consumer for use in authenticating the consumer, a consumer personal asset database, and/or a mobile payment device application. The secure storage component 112 may be, for example, a secure element of a mobile telephone, and it should also be understood that such a secure storage component may include any and all types of non-transitory computer-readable media, with the sole exception being a transitory, propagating signal.

Referring again to FIG. 1, the mobile telephone 102 also includes receive/transmit circuitry 118 that is also in communication with and/or controlled by the mobile device processor 108. The receive/transmit circuitry 118 is operably coupled to an antenna 120 and provides the communication channel(s) by which the user of the mobile telephone 102 can use to communicate with others via a mobile network and/or via the internet and/or any other type of communications network(s). The mobile telephone 102 further includes a microphone 122 operably coupled to the receive/transmit circuitry 118. The microphone 122 may be utilized for various purposes, such as for receiving voice input from the user or consumer for authentication and/or communication purposes. In addition, a loudspeaker 124 is operably coupled to the receive/transmit circuitry 118 and operable to provide sound output to the user, for example, during a cell phone call.

As shown in FIG. 1, the mobile telephone 102 may also include one or more sensors and/or circuitry and/or devices and/or components that function to obtain and/or provide and/or communicate data concerning the consumer's mobile device and/or the user or consumer. In particular, the mobile telephone 102 may be a smartphone that includes an integrated camera 126 operably connected to the mobile device processor 108 and that can be utilized for various functions. For example, the integrated camera 126 can take pictures or photographs that may be stored in the storage device 110 and/or shared with others. The integrated camera 126 may also be operated to read two-dimensional (2D) barcodes to obtain information (for example, reading a barcode printed on a page of a magazine or newspaper advertising a product or service), and/or to take a picture of the mobile device user or consumer for authentication purposes. The mobile telephone 102 may also include Global Positioning System (GPS) circuitry 128 operably connected to the mobile device processor 108, which may generate information or data concerning the location of the mobile telephone 102. In addition, the mobile telephone 102 may include one or more biometric sensors 130, which may include, but are not limited to, motion sensors, a fingerprint sensor, and a biochemical sensor. Such biometric sensors can be utilized to authenticate a user or consumer during a purchase transaction based on, for example, data from a motion sensor related to the user's walking style or gait, and/or force data associated with the force generated by the user's finger when he or she touches the touch screen 116, and/or fingerprint data, and/or breath data (and/or other types of data associated with the user) obtained from the user of the mobile device 102. In some embodiments, one or more of the mobile device components may be utilized in concert with a mobile device payment application in accordance with processes described herein.

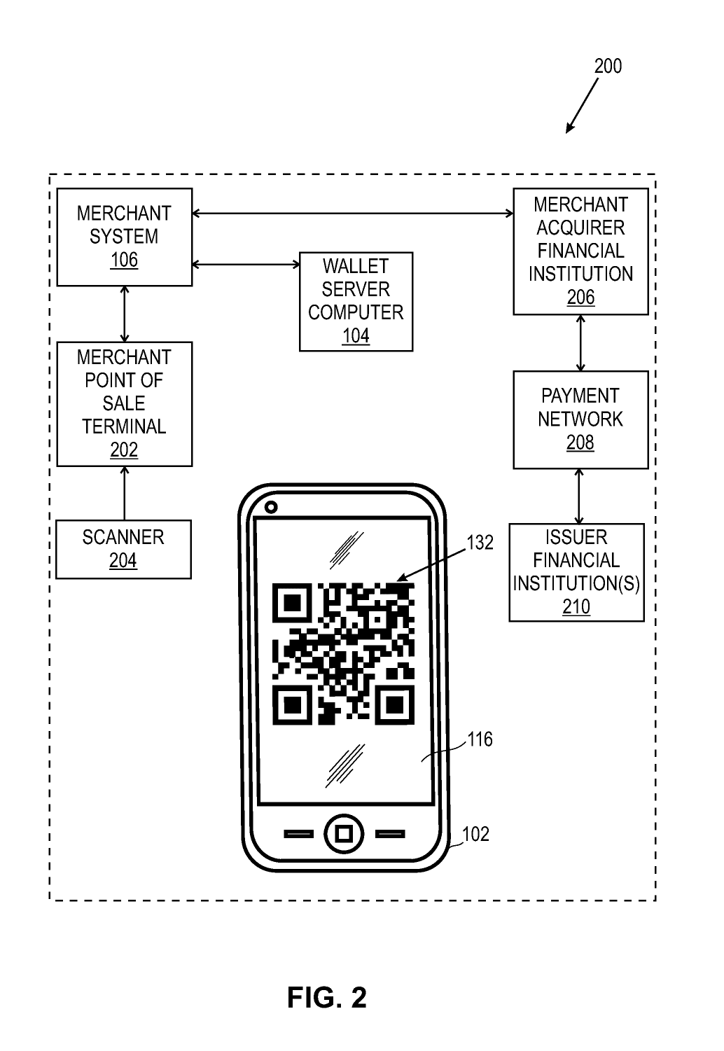

In some embodiments, a secure mobile wallet application that operates with the consumer's mobile wallet is stored in the secure storage component 112. The secure mobile wallet application may be downloaded by the consumer onto his or her consumer mobile device 102 (for example, onto an iPhone™ or an Android™ smartphone, a tablet computer such as an iPad™, a laptop computer, a digital music player, a personal digital assistant (PDA) and the like). The secure mobile wallet application may be available for downloading from the manufacturer of the consumer's mobile device, and/or from a mobile network operator (MNO) associated with the consumer, or from the consumer's issuer financial institution (i.e., issuer bank of the consumer's payment card account), and/or from a third party service provider (SP) such as a payment system operator (such as MasterCard International Incorporated, the assignee of the present application). For example, a consumer or merchant may be able to obtain the secure mobile wallet application from one or more suppliers, such as from an application store (such as iTunes™ and/or Google Play™), from an issuer FI 210 (shown in FIG. 2) of the consumer's payment card account and/or from a third-party applications provider (not shown).

Referring again to FIG. 1, in some implementations when the consumer's mobile device has connectivity to a network, then the secure mobile wallet application operates to cause the mobile device processor 108 to request at least one Wallet Single Use Key (W_SUK) and Transaction Identifier (Tx ID) from the wallet server computer 104. For example, when the mobile device 102 is connected to the internet (or to a cellular network), in some implementations, the secure mobile wallet application may first check to see if any W_SUKs and Tx IDs are available in the secure storage component 112. If not, then the secure mobile wallet application operates to cause the Mobile Wallet identifier to be transmitted to the wallet server 104 with a request for a number of wallet single use keys (W_SUKs) and transaction identifiers (Tx IDs). The number of wallet single use keys and associated transaction identifiers that can be requested at the same time may be predetermined by a financial institution (for example, the issuer financial institution that issued the consumer's payment card account(s), such as a credit card account and/or debit card account and/or a pre-paid card accounts), or may be pre-set in some implementations by the consumer or mobile device user. In some embodiments, a maximum amount of wallet single use key and associated transaction identifier pairs can be requested at one time (in one request), such as six pairs.

When the Wallet Identifier (ID) and the request for wallet single use keys and transaction identifiers is received, the wallet server computer 104 then generates new transaction identifiers (Tx IDs), wallet session keys (W_SKs) and wallet single use keys (W_SUKs) for that Wallet ID. In some implementations, a W_SK is derived by concatenating a Tx ID with the Wallet ID. Similarly, in some embodiments, a W_SUK is derived as the exclusive-OR (XOR) of the W_SK and a mobile personal identification number (Mobile PIN) associated with the consumer. In most cases, the Mobile PIN is provided to the Wallet Server as part of provisioning the Mobile Wallet on the consumer's mobile device. (Mobile device provisioning processes are known and thus will not be described in detail herein.) Therefore, in some embodiments:

W_SUK=(W_SK)XOR(Mobile PIN)

In some embodiments, the wallet server computer 104 then transmits a plurality of W_SUKs and Tx IDs to the consumer's mobile device 102, which receives and stores the W_SUKs and Tx IDs in the secure storage component 112. As mentioned above, in a typical scenario, a predetermined number of mobile wallet single use keys (W_SUKs) and transaction identifiers (Tx IDs) will be returned and stored on the mobile device for each request. Thus, once the wallet single use keys and transaction identifiers are stored on the consumer's mobile device, they can be used subsequently for payment transactions when there is no network access available (for example, the consumer's mobile device is offline and/or has no connectivity with the internet and/or with any cellular networks), as explained below.

FIG. 2 is a block diagram of a payment system 200 of a type that can be used by a consumer with a mobile device which is offline to conduct purchase transactions in accordance with novel aspects disclosed herein. The payment system 200 includes a wallet server computer 104, a merchant system 106, a merchant point-of-sale (POS) terminal 202 and associated scanner 204 (which may be a scanner device, a barcode reader, or another type of reader device and the like), a merchant acquirer financial institution (FI) 206, a payment network 208, and one or more issuer FIs 210. Also shown in a consumer's mobile device 102, which for illustrative purposes is shown as a smartphone and which includes a touch screen 116. As shown, the merchant POS terminal 202 is operably connected to the merchant system 116, which is configured for communications with the wallet server computer 104 and with the merchant acquirer FI 206. The merchant POS terminal 202 may be a specialized electronic device, such as an electronic Point-of-Sale (POS) device (such as an electronic cash register or desktop computer) having a display screen and one or more electronic components configured to process purchase transactions. Such an electronic POS device also is capable of receiving information and/or data from remote computers and/or computer networks in the manner described herein. As also shown in FIG. 2, the merchant acquirer FI 206 is configured for communication with the payment network 208, which in turn can communicate with one or more of the issuer FIs 210.

It should be understood that some of the various components shown in FIG. 2 may be a subset of a larger system, and that more or less components and/or devices may be utilized. For example, although only one merchant acquirer FI computer 206 and only one issuer FI computer 210 are shown, in some practical embodiments, a plurality of such components, as well as a plurality of payment networks 208, may be utilized. In addition, although specific embodiments are described herein, it should be understood that this is for illustrative purposes only and that different components and/or configurations could be used without departing from the spirit and scope of this disclosure.

Referring again to FIG. 2, a consumer desiring to initiate a purchase transaction in a merchant's retail store (for example, a retail location which does not have, or does not offer, wireless connectivity either via the internet or via a wireless network) initializes a secure mobile wallet application stored on the consumer's smartphone 102. In some implementations, the secure mobile wallet application functions to display a prompt on the display screen 116 to the consumer to select a payment card account from a plurality of payment card account options stored in the mobile wallet. After making a selection, in an embodiment the consumer is prompted to enter a Mobile personal identification number (Mobile PIN). At this point, in some embodiments, the secure mobile wallet application may determine that the consumer's mobile device is not wirelessly connected to any network (and thus is offline) or may determine that there is a network connection. In any case, the secure mobile wallet application locates and retrieves a mobile wallet single use key (W_SUK) which was stored previously in the secure storage component 112 (see FIG. 1) of the mobile device 102. The W_SUK is then used to derive a wallet session key (W_SK) as the exclusive-OR (XOR) of the W_SUK and the Mobile PIN entered by the user or consumer. Therefore, in some embodiments:

W_SK=(W_SUK)XOR(Mobile PIN)

The mobile application next encrypts the transaction data using the wallet session key (W_SK) using techniques known to one skilled in the art. In some embodiments, the transaction data includes, but is not limited to, the transaction identifier (Tx ID), the Wallet ID, a payment card ID and/or a timestamp. After the transaction data is encrypted, a machine readable code 132, such as a quick response (QR) code, is generated and displayed on the touch screen 116 of the mobile device 102. QR codes are mobile device readable bar codes that can store data, such as website uniform resource locators (URL's), plain text, phone numbers, e-mail addresses and other types of alphanumeric data. For example, in the example shown in FIG. 2, the QR code 132 may be generated utilizing a QR code generator application running on the smartphone 102, and then the QR code is displayed on the touch screen 116, as shown, for a particular purchase transaction. Therefore, in some embodiments the process includes:

Encrypt (W_SK, Transaction Data) and use result to generate QR code.

Thus, in such an embodiment, the QR code represents an encoded version of the Tx ID, timestamp and the encrypted data.

Referring again to FIG. 2, in order to initiate payment processing, the consumer presents his or her smartphone 102 to the merchant's POS terminal 102 so that the QR code 132 can be scanned by the scanner 204. Thus, the scanner 204 reads the QR Code 132 and passes the encoded data containing the Tx ID, the timestamp and the encrypted data to the Merchant System 106. The Merchant System 106 then passes the encoded data and additional transaction information to the Wallet Server computer 104, which decrypts the transaction data and also verifies and/or validates the transaction data. In some embodiments, the Wallet Server computer 104 then looks up the Wallet Session Key (W_SK) using the transaction identifier (Tx ID) which was received from the QR Code 132. The Wallet Server computer 104 utilizes the W_SK to decrypt the transaction data and to retrieve the Tx ID, the timestamp, the Wallet ID and the payment card ID. Next, the Wallet Server computer 104 compares the Tx ID and the timestamp decrypted from the transaction data with the Tx ID and the timestamp passed from the QR Code 132. If the values match, then the purchase transaction can proceed. If the values do not match, then an “error” message or a “transaction denied” message is generated and transmitted from the Wallet Server computer 104 to the Merchant System 106, which then transmits that message to the merchant's POS terminal 202 for display to the consumer. In this case, the merchant does not allow the purchase transaction to continue but may permit the consumer to use an alternate form of payment.

Referring again to FIG. 2, if the Tx ID and the timestamp decrypted from the transaction data matches the Tx ID and the timestamp passed from the QR Code 132, then the Wallet Server computer 104 pairs the Tx ID with the related Wallet ID and the Card ID, and then makes a determination of whether the purchase transaction is for a specific primary account number (PAN) of a payment card account, or if it relates to a Token (which is a randomly generated number that replaces a payment card account number). The Wallet Server computer 104 then passes either the PAN or the Token along with an expiration date to the Merchant System computer 106, which generates an authorization request message. The Merchant System computer 106 then transmits the purchase authorization request message to the Merchant Acquirer FI 206 for payment processing. In a typical scenario, the Merchant Acquirer FI 206 transmits the purchase transaction authorization request message to the payment network 208, which determines which issuer FI 210 of a plurality of issuers is the financial institution that issued the consumer's payment card account.

The payment network 208 then transmits the authorization request message to the appropriate issuer FI 210, which determines whether or not to authorize the purchase transaction (for example, by checking to make sure that the consumer's payment card account is in good standing and has adequate credit available to cover the purchase price). If all is in order, the issuer FI 210 transmits an authorization response message to the payment network 208, which passes it to the Merchant Acquirer FI 206, which in turn passes it to the Merchant System 106. The Merchant System 106 then transmits that authorization response message to the POS terminal 202, which may display it on a display component (not shown) for the benefit of the merchant and consumer, and the merchant then permits the consumer to leave the retail store with the selected merchandise.

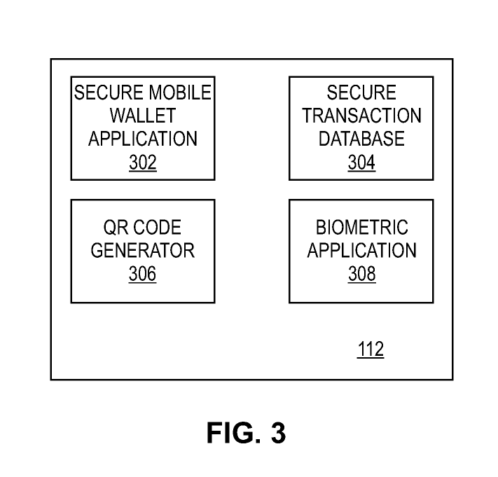

FIG. 3 is a block diagram of a secure storage component 112 or memory of a consumer's mobile device to illustrate some software aspects according to embodiments. As described earlier, the consumer downloads a secure mobile wallet application 302. The consumer has provisioned the mobile wallet application 302 so that it contains personal financial data, such as data concerning one or more credit card accounts, debit card accounts, reward card accounts, gift card accounts, merchant loyalty card accounts, and/or other types of financial accounts and the like. As is known, such a mobile wallet application can be used by the consumer to conduct electronic payment transactions with a merchant, for example, by selecting a payment card account from the application and then providing identification data (such as a Mobile PIN) that authenticates the consumer to the payment network 208 (see FIG. 2). The secure storage component 112 may also include a secure transaction database 304 for storing one or more single use keys and transaction identifiers (W_SUKs and Tx IDs) received from a Mobile Wallet server computer 104, and a QR Code generator application 306. Such a QR code generator 306 may utilize encrypted wallet session key (W_SK) and encrypted transaction data to generate a QR code for a single transaction, as described herein. The secure storage component 112 may also include a biometric application 308 for obtaining biometric information from the consumer and which may also include biometric data (which may have been obtained from a consumer or user during an enrollment or registration process). The biometric data may include, but is not limited to, face data (i.e., a picture taken with a mobile device camera of the user's face, and/or iris scan data), fingerprint data, voice data, audible data (for example, voice data and/or hand clapping sounds), a walking style data, and/or encrypted data.

As described herein, during a purchase transaction the payment network 208 typically coordinates processing between an issuer FI 210 that issued the consumer's payment card account, and the merchant acquirer FI 206 associated with the merchant. If all is in order (i.e., the payment system authenticated the consumer and was informed that the consumer's payment card account is in good standing and has a sufficient credit line to cover the transaction amount thus authorizing the purchase transaction), then the purchase transaction is consummated. In accordance with processes disclosed herein, the consumer may download and utilize a secure mobile wallet application 302 to easily and securely conduct purchase transactions without the need for the consumer's mobile device to be online or connected to a network. It should be understood that, in some embodiments, consumers, payment networks, Issuer FIs and/or Acquirer FIs may be required to enroll in or to register with a service provider who provides the secure mobile wallet application service (for example, via a website or webpage hosted by a service provider) before secure transaction processing can occur as described herein.

Referring again to FIG. 3, in some embodiments, the secure mobile wallet application program 302 is operable to determine a type of transaction that is occurring, and based on that determination and/or data supplied by the consumer, to prompt the mobile device user for one or more of user identifiable biometric data and/or personal data in order to authenticate the user or consumer. In some implementations, the consumer would then utilize one or more of the biometric sensors 130, camera 126, microphone 122 and/or touch screen 116 (see FIG. 1) of his or her mobile device 102 to provide such information during the purchase transaction.

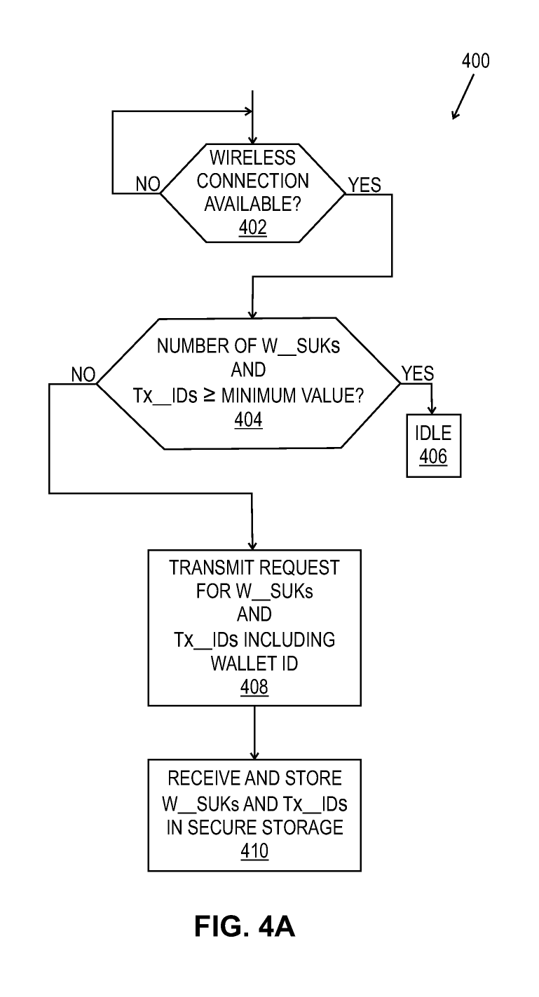

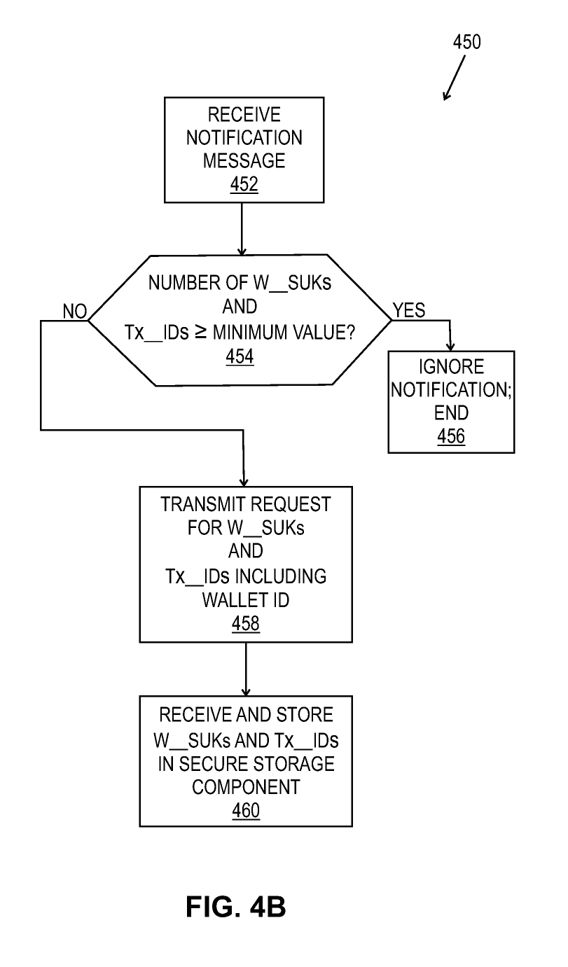

FIG. 4A is a flowchart illustrating a secure mobile wallet application pre-loading process 400 in accordance with novel aspects described herein. The secure mobile wallet application periodically checks 402 to see if a wireless connection is available for the consumer's mobile device. If not, then the process idles, but if wireless connectivity is available, then the process includes checking 404 to see if the number of single use keys and transaction identifiers in the secure storage component is greater than or equal to a minimum value (which value can be determined and/or configured by the mobile wallet provider). If so, then the process idles 406. But if the mobile wallet application determines 404 the number of single use keys and transaction identifiers is below the minimum value (i.e., less than a required threshold amount), then the secure mobile wallet application causes the mobile device processor to transmit 408 a request for one or more Wallet Single Use Keys (W_SUK) and one or more Transaction Identifiers (Tx ID) from a wallet server computer. In some embodiments, the number of wallet single use keys and associated transaction identifiers that can be requested at one time may be predetermined by a financial institution (for example, the issuer financial institution that issued the consumer's payment card account(s)), or it may be pre-set in some implementations by the consumer or mobile device user. The wallet server then generates new Tx IDs, W_SKs and wallet single use keys (W_SUKs) for that Wallet ID and transmits them to the consumer's mobile device 102. The secure mobile wallet application then causes the mobile device processor to receive and store 410 the W_SUKs and Tx IDs in the secure storage component, and the pre-loading process ends. The W_SUKs and Tx IDs can then be used for payment transactions when there is no network access available and thus wherein the consumer's mobile device is offline.

FIG. 4B is a flowchart 450 illustrating another embodiment of a secure mobile wallet application pre-loading process in accordance with novel aspects described herein. When the secure mobile wallet application receives 452 a notification message from a Wallet Server computer, then it determines 454 if the number of single use keys and transaction identifiers in the secure storage component is greater than or equal to a minimum value (which value can be determined by the mobile wallet provider). If so, then the secure mobile wallet application ignores 456 the notification. But if the mobile wallet application determines 454 the number of single use keys and transaction identifiers is below the minimum value (less than a required threshold amount), then the secure mobile wallet application causes the mobile device processor to transmit 458 a request to download one or more Wallet Single Use Keys (W_SUK) and one or more Transaction Identifiers (Tx ID) from the Wallet Server computer. As mentioned herein, the number of wallet single use keys and associated transaction identifiers that can be requested at one time may be predetermined by a financial institution (for example, the issuer financial institution that issued the consumer's payment card account(s)), or may be pre-set in some implementations by the consumer or mobile device user. The Wallet Server computer then generates new Tx IDs, W_SKs and wallet single use keys (W_SUKs) for that Wallet ID and transmits them to the consumer's mobile device 102. The secure mobile wallet application then causes the mobile device processor to receive and store 460 the W_SUKs and Tx IDs in the secure storage component, and the pre-loading process ends. The W_SUKs and Tx IDs can then be used for payment transactions when there is no network access available and thus wherein the consumer's mobile device is offline.

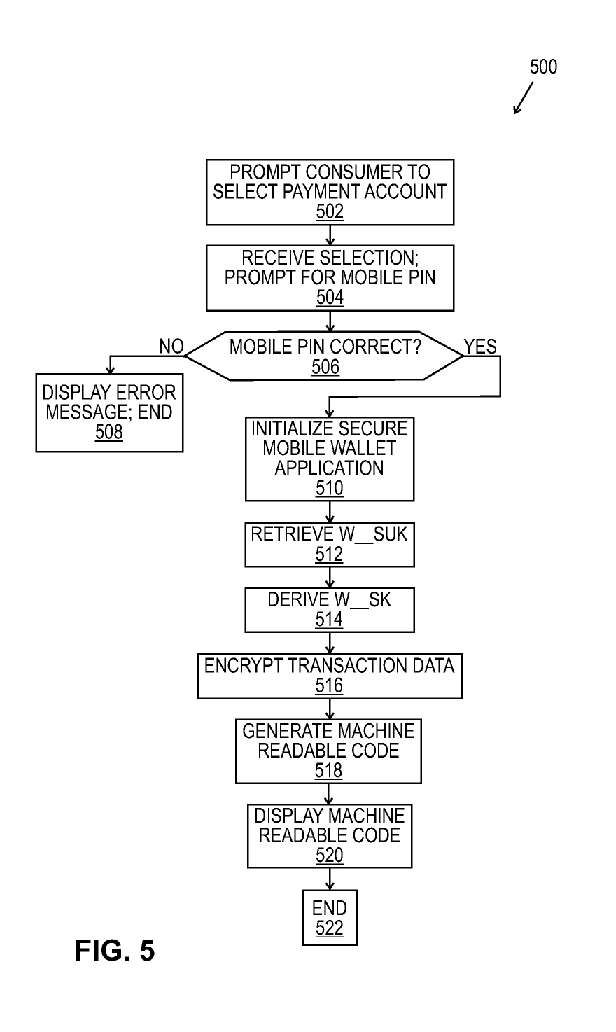

FIG. 5 is a flowchart of a secure offline purchase transaction 500 in accordance with disclosed aspects. In some embodiments, when the consumer wishes to use his or her mobile device to pay for a purchase, he or she initiates the mobile wallet application which includes instructions that cause the mobile device processor to prompt 502 the consumer to select a payment account from a plurality of payment card account options stored in the mobile wallet. After a payment account is selected, in some embodiments, the secure mobile wallet application then causes the mobile device processor to prompt 504 the consumer to enter a Mobile PIN. The mobile device processor then determines 506 if the Mobile PIN is correct, and if not, then an “Incorrect Mobile PIN” error message (or similar message) may be displayed 508 on the display screen of the mobile device and the process ends. In some implementations, the consumer may be permitted to retry entering the Mobile PIN before the secure mobile wallet application closes. For security reasons, in some implementations, the secure mobile wallet application may be locked in a closed state after an initial Mobile PIN entry does not match a stored Mobile PIN, or after a predetermined number of incorrect Mobile PIN entries are attempted (for example, to prevent a thief from making purchases with a stolen mobile device). If this occurs, in some embodiments, the user is then directed to contact the mobile wallet provider for assistance.

Referring again to FIG. 5, if the mobile device processor determines 506 that the Mobile PIN entry is correct, then the mobile device processor initiates 510 the secure mobile wallet application. As explained earlier, the secure mobile wallet application includes instructions configured to cause the mobile device processor to locate and retrieve 512 a mobile wallet single use key (W_SUK) which was stored previously (pre-loaded) in the secure storage component 112 (see FIG. 1) of the mobile device 102 as described herein. The secure mobile wallet application then causes the mobile device processor to derive 514 a wallet session key (W_SK) from the W_SUK, which in some embodiments is the exclusive-OR (XOR) of the W_SUK and the Mobile PIN. Next, the mobile device processor encrypts 516, using techniques known to one skilled in the art, the transaction data (which may include, but is not limited to, the transaction identifier (Tx ID), the Wallet ID, a payment card ID and/or a timestamp) using the W_SK. After the transaction data is encrypted, in some implementations, the secure mobile wallet application causes a QR code generator to generate 518 the QR code (which is a machine readable code) and then causes the mobile device processor to display 520 the QR code on a display screen of the consumer's mobile device, and the process then ends 522. In some embodiments, the QR code is displayed for a predetermined amount of time (for example, for up to 30 seconds), after which time expires the QR code disappears from the display screen (for security purposes). The length of time that such a QR code is displayed may be determined by the secure mobile wallet application provider or other entity, and may be handled by the secure mobile wallet application.

When the QR code is displayed on the screen, the consumer then presents the display screen of his or her mobile device to a scanner or QR code reader connected to a merchant's POS terminal so that the QR code can be scanned. The merchant's scanner reads the QR Code and passes the encoded data containing the Tx ID, the timestamp and encrypted data to the Merchant System, which passes the encoded data and additional transaction information to the Wallet Server computer. The Wallet Server computer then decodes and/or decrypts the transaction data and also verifies and/or validates the transaction data. As explained above, in some embodiments the Wallet Server computer looks up the W_SK using the Tx ID, and then uses the W_SK to decrypt the transaction data and to retrieve the Tx ID, the timestamp, the Wallet ID and the payment card ID. Next, the Wallet Server compares the stored Tx ID and the timestamp with the Tx ID and the timestamp passed from the QR Code 132. If the values match, then the purchase transaction proceeds. But if the values do not match, then an “error” message or a “transaction denied” message is generated and transmitted from the Wallet Server computer to the Merchant system, which then transmits that message to the merchant's POS terminal 202 for display to the consumer.

However, if the Tx ID and the timestamp decrypted from the transaction data matches the stored Tx ID and the timestamp, then the Wallet Server computer pairs the Tx ID with the related Wallet ID and the Card ID, and makes a determination of whether the purchase transaction is for a specific primary account number (PAN) of a payment card account, or if it relates to a Token. The Wallet Server computer 104 then passes either the PAN or the Token along with an expiration date to the Merchant System computer 106, which generates an authorization request message. The Merchant System computer 106 then transmits the purchase authorization request message to the Merchant Acquirer FI 206 for payment processing in a typical manner. For example, the Merchant Acquirer FI 206 may transmit the purchase transaction authorization request message to a payment network 208 which determines which issuer FI 210 of a plurality of issuers is the financial institution that issued the consumer's payment card account. The payment network 208 then transmits the authorization request message to the appropriate issuer FI, which determines whether or not to authorize the purchase transaction. If all is in order, the issuer FI 210 transmits an authorization response message to the payment network 208, which passes it to the Merchant Acquirer FI 206, which passes it to the Merchant System computer 106 for transmission to the Merchant's POS terminal 202. The purchase transaction approval message may then be displayed on a display component (not shown) for the benefit of the merchant and consumer, and the merchant then permits the consumer to leave the retail store with the selected merchandise.

Such a process is easy to implement and utilizes existing payment card account network components and/or technology. Furthermore, the disclosed payment methods and systems are secure, and the user authentication and/or purchase transaction authorization processes are transparent to the consumer. In particular, the consumer authentication process and purchase transaction authorization process appears to the consumer to have been handled locally, in the merchant's retail location.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method for conducting a purchase transaction with a mobile device comprising:
receiving, by a mobile device processor, an indication to conduct a purchase transaction;
initializing, by the mobile device processor, a secure mobile wallet application;
receiving, by the mobile device processor, a selection of a payment account from a plurality of stored payment accounts;
retrieving, by the mobile device processor from a secure storage component, a pre-loaded wallet single use key (W_SUK);
deriving, by the mobile device processor, a wallet session key (W_SK) utilizing the W_SUK;
encrypting, by the mobile device processor, transaction data using the W_SK;
generating, by the mobile device processor, a machine readable code utilizing the encrypted transaction data; and
displaying, by the mobile device processor on a display screen, the machine readable code for reading by a merchant scanner to conduct a purchase transaction.

2. The method of claim 1, wherein deriving the W_SK comprises:
receiving, by the mobile device processor, input of a Mobile personal identification number (Mobile PIN) from a consumer; and
generating, by the mobile device processor, the W_SK by taking the exclusive-OR (XOR) of the W_SUK and the Mobile PIN.

3. The method of claim 1, wherein the transaction data comprises at least two of a pre-loaded transaction identifier (Tx ID) associated with the W_SUK, a Wallet ID, a payment card ID, and a timestamp.

4. The method of claim 1, further comprising, prior to receiving the indication to conduct a purchase transaction:
determining, by the mobile device processor, that wireless connectivity is available for the mobile device;
determining, by the mobile device processor, that the number of wallet single use keys and transaction keys stored in the secure storage component is less than a predetermined minimum value;
requesting, by the mobile device processor from a Wallet Server computer, a predetermined number of wallet single use keys and transaction identifiers;
receiving, by the mobile device processor from the Wallet Server computer, the requested number of wallet single use keys and transaction identifiers; and
storing, by the mobile device processor, the wallet single use keys and transaction identifiers in the secure storage component.

5. The method of claim 4, wherein the predetermined minimum value is determined by a secure mobile wallet provider.

6. The method of claim 4, wherein the number of wallet single use keys and associated transaction identifiers that can be requested at one time is predetermined by one of a financial institution or a secure mobile wallet provider.

7. The method of claim 4, wherein the number of wallet single use keys and associated transaction identifiers that can be requested at one time is pre-set by a consumer.

8. The method of claim 1, further comprising, prior to receiving the indication to conduct a purchase transaction:
receiving, by the mobile device processor, a notification message from a Wallet Server computer;
determining, by the mobile device processor, that the number of wallet single use keys and transaction keys stored in the secure storage component is less than a predetermined minimum value;
requesting, by the mobile device processor from a Wallet Server computer, a predetermined number of wallet single use keys and transaction identifiers;
receiving, by the mobile device processor from the Wallet Server computer, the requested number of wallet single use keys and transaction identifiers; and
storing, by the mobile device processor, the wallet single use keys and transaction identifiers in the secure storage component.

9. The method of claim 8, wherein the predetermined minimum value is determined by a secure mobile wallet provider.

10. The method of claim 8, wherein the number of wallet single use keys and associated transaction identifiers that can be requested at one time is predetermined by one of a financial institution or a secure mobile wallet provider.

11. The method of claim 8, wherein the number of wallet single use keys and associated transaction identifiers that can be requested at one time is pre-set by a consumer.

12. The method of claim 1, wherein the machine readable code is a quick response (QR) code.

13. The method of claim 1, further comprising, after initializing the secure mobile wallet application:
prompting, by the mobile device processor, a consumer to enter a mobile personal identification number (mobile PIN);
determining, by the mobile device processor, that the mobile PIN is correct; and
prompting, by the mobile device processor, a consumer to select a payment account from a plurality of payment accounts stored in the secure storage component.

14. The method of claim 1, further comprising, after initializing the secure mobile wallet application:
prompting, by the mobile device processor, a consumer to enter a mobile personal identification number (mobile PIN);
determining, by the mobile device processor, that the mobile PIN is incorrect;
displaying, by the mobile device processor on a display screen, an error message; and
terminating, by the mobile device processor, the purchase transaction.

15. A payment system comprising:
a mobile device comprising a mobile device processor operably connected to a secure storage component, a wireless transceiver, and a display screen;
a merchant point-of-sale (POS) terminal operably connected to and scanner device;
a merchant system in communication with the merchant POS terminal; and
a wallet server computer in communication with the merchant system;
wherein the secure storage component of the mobile device stores instructions configured to cause the mobile device processor to:
receive an indication to conduct a purchase transaction;
initialize a secure mobile wallet application;
receive a selection of a payment account from a plurality of stored payment accounts;
retrieve a pre-loaded wallet single use key (W_SUK) from the secure storage component;
derive a wallet session key (W_SK) utilizing the W_SUK;
encrypt transaction data using the W_SK;
generate a machine readable code utilizing the encrypted transaction data; and
display the machine readable code on the display screen for reading by the scanner to conduct a purchase transaction.

16. The payment system of claim 15, wherein the scanner device associated with the POS terminal reads the machine readable code from the display screen of the mobile device, and the POS terminal transmits the encrypted transaction data comprising a Tx ID, a timestamp and the encrypted data to the merchant system for transmission to the Wallet server computer.

17. The payment system of claim 16, wherein the Wallet server:
receives the encrypted transaction data;
obtains a W_SK from a storage component based on at least a portion of additional transaction data;
decrypts the encrypted transaction date based on the W_SK to obtain a Tx ID, a timestamp, a Wallet ID and a payment card ID; and
determining to proceed with the purchase transaction when the Tx ID and the timestamp decrypted from the transaction data match a stored Tx ID and the timestamp passed from the QR Code.
